(19) United States
(12) Patent Application Publication
(10) Pub. No.: US 2003/0014636 A1
(43) Pub. Date: Jan. 16, 2003

(54) Physical identification and computer security apparatus and method

(76) Inventor: Stephen D Ahlbrand, Columbia, MD (US)

Correspondence Address: Office of Patent Counsel, The Johns Hopkins University, Applied Physics Laboratory, 11100 Johns Hopkins Road, Laurel, MD, 20723-6099, US

(21) Appl. No.: 10/182,155

(22) PCT Filed: Feb. 1, 2001
(86) PCT No.: PCT/US01/03239

(30) Foreign Application Priority Data
Feb. 1, 2000 (US) 60179496

(51) Int. Cl. H04L 9/00

(52) U.S. Cl. 713/176

(57) ABSTRACT

A computer storage medium (CSM) includes identification information such as name, ID number, picture, and other routine identification information. Data stored on the CSM can include security data, encryption data, programs, and network logon executables. A secure computer network is accessed by inserting the CSM into a computer. The computer can automatically run an executable resident on the CSM or it can be manually triggered by the user. The executable prompts the user for a password. The CSM contains a user ID that was encoded when it was issued to the user. The user inputs their password and the network authenticates the user ID/password combination granting or denying access to the network. The CSM can install a memory resident process that provides on-line encryption capability for data, and can be incorporated into a computer security system that includes a secure key distribution system. Digital signature capability can also be implemented.

### BACKGROUND OF THE INVENTION

The present invention relates to a system that utilizes removable computer storage medium displaying and containing personal identification and digital signature data as well as storing executable programs that utilize the personal identification and digital signature data.

There are numerous badging systems in use by companies and organizations worldwide. The purpose of such badging systems is to provide at least one level of security in that the bearer of a badge is who they purport to be based on the information contained on the badge. One means of verification is physical inspection of the badge by a third party such as a security guard. A typical badge would therefore contain, at a minimum, the name and picture of the individual.

Additional layers of security have been added to identification badges over time. For instance, some badges now include a bar code identifier that must be swiped by a bar code reader to gain access to a physical plant or other resources. Or, a magnetic strip may be present on a badge that must be swiped through a magnetic strip reader. This additional level of security means that a security guard need not be present at each internal point of entry to secure areas or resources. Rather, a common entry point may be employed for physical inspection while other entries may rely on an electronic badging method. For convenience, the electronic means (bar code, magnetic strip, or other suitable means) may be incorporated directly into the physical badge.

We now live in a computer and data intensive world. Security with respect to access to computers, computer networks, and electronic data in general is just as important as security with respect to access of physical plants. More often than not computers and computer networks containing sensitive data reside within the parameters of a secure physical plant. However, not everyone with authorized access to a physical plant is authorized access to certain aspects of computer networks or computer data. Thus, computers typically have their own means of security that are independent of the aforementioned badging systems.

The most common form of computer security is the un-encrypted User ID and Password combination. This is where an individual accesses computer resources and data by inputting a user ID and password combination unique to that individual and known to the “computer system”. The computer system compares the input user ID and password combination against its list of user IDs and password combinations and grants access to the “computer system” only when a valid combination has been entered.

Stronger authentication techniques have become necessary that combine the physical possession aspects of a badge with the user's ability to enter an ID and a password from memory. Thus, physical possession of the badge is not enough, as the password must also be known. Similarly knowing the user's password is not enough, as the physical badge must also be obtained.

More recently, digital signatures have become widespread. A digital signature is the electronic equivalent of a handwritten signature on a document. Once an electronic document is electronically signed, the signer cannot deny the signature and the recipient is assured of the validity of both the document and the sender. A digital signature verifies that the document originated from the signor and has not been altered since it was digitally signed.

Another security issue related to digital signatures is data encryption. In short, data encryption is a process that scrambles the original data according to a mathematical formula. The data is then sent to a recipient who unscrambles the data using a corresponding mathematical formula. These formulas are often referred to as keys. Unless the recipient has the proper key, the data will remain scrambled and unreadable.

What is needed is a means for performing all of the functions heretofore described using a single physical means of identification that can be readily used by the majority of computers in use today such that no additional hardware need be added to an individual computer or a computer system.

### SUMMARY OF THE INVENTION

A removable computer storage medium described generally as a “Pocket CD” currently exists. A pocket CD is a storage medium similar to a standard compact disc (CD) with the notable exception of its physical size. Pocket CDs have a diameter of 3⅛ inches as opposed to a standard CD diameter of 4¾ inches. Thus, pocket CDs are more portable. They can be inserted into a protective case and worn around the neck as a lanyard or clipped to clothing. The pocket CD, as well as other removable computer storage mediums, such as DVD's, can be imprinted with identification information such as name, ID number, picture, bar code, and/or other routine identification information.

The stored data on the removable computer storage medium includes, among other things, encrypted security data, encryption data, and network logon scripts or executables. In order to access a secure computer network, one would insert his or her removable computer storage medium into the CD/CD-RW/DVD tray, floppy disk drive, zip disk drive, or other suitable receptacle on a given computer depending on the removable computer storage medium chosen. For CD based implementations, conventional trays are designed to accommodate both standard and pocket sized CDs. Thus, implementation of the present invention would not require additional specialized hardware to be added to the individual computers or other peripherals of the network.

The present invention implements what is commonly referred to as “Strong Authentication”. Strong authentication is comprised of a physical aspect, something you possess—the removable computer storage medium and a knowledge aspect, something you know—your ID and/or password. A PIN (personal identification number) is analogous to a password in that it is a unique set of characters (usually numbers) assigned to a unique user ID. Thus, for purposes of this document a PIN and a password are considered as equivalents, and can be either letters, numbers or a combination of letters and numbers.

The chosen computer will boot up in a conventional manner, if it has not done so already. The removable computer storage medium would not interfere with the computer's boot up procedures. Upon booting up the computer would automatically run an executable resident on the removable computer storage medium. Alternatively, the executable could be manually triggered by the user by accessing the drive containing the removable computer storage medium. The executable may also have been previously installed on the computer system. The executable would prompt the user for a password. The removable computer storage medium already contains a user ID that was encoded when it was issued to the user. The user would input his or her password and the network would then authenticate the user ID/password combination. Upon authentication the user may access the network. The logon process could be a replication of existing manual logon processes or it can be enhanced to utilize encryption data that would be resident on the removable computer storage medium.

In addition to performing a network logon procedure, the executable could also install a memory resident process that would provide in-line encryption capability for data. The encryption can be based on the Public Key Infrastructure (PKI) or Symmetric Key Encryption technology, which are readily available. Other encryption techniques, however, may be implemented without departing from the spirit or scope of the present invention.

With the inclusion of encryption key(s) on the removable computer storage medium, digital signature capability can be implemented for electronic documents requiring digital signatures. Electronic documents requiring digital signature can be automatically processed to result in a digital signature. Or, a digital signature process can be performed independent from the need to modify an existing document that was prepared as an electronic computer file. This independent process comprises a software application resident on the removable computer storage medium that would facilitate the handling of a computer file in order to electronically (digitally) sign it. The independent process would be separately executable from other scripts or executables resident on the removable computer storage medium.

### BRIEF DESCRIPTION OF THE DRAWINGS

FIG. 1 illustrates a first example of a physical representation of a removable computer storage medium.

FIG. 2 illustrates a second example of a physical representation of a removable computer storage medium.

FIG. 3 illustrates a third example of a physical representation of a removable computer storage medium.

FIG. 4 is a block diagram illustrating the programs and data stored on a removable computer storage medium.

FIG. 5 is a flowchart describing a log-in procedure.

FIG. 6A is a flowchart describing a data encryption procedure utilizing a removable computer storage medium.

FIG. 6B is a flowchart describing a data de-encryption procedure.

FIG. 7A is a flowchart describing a digital signature procedure utilizing a removable computer storage medium.

FIG. 7B is a flowchart describing a digital signature de-encryption procedure

### DESCRIPTION OF THE PREFERRED EMBODIMENTS

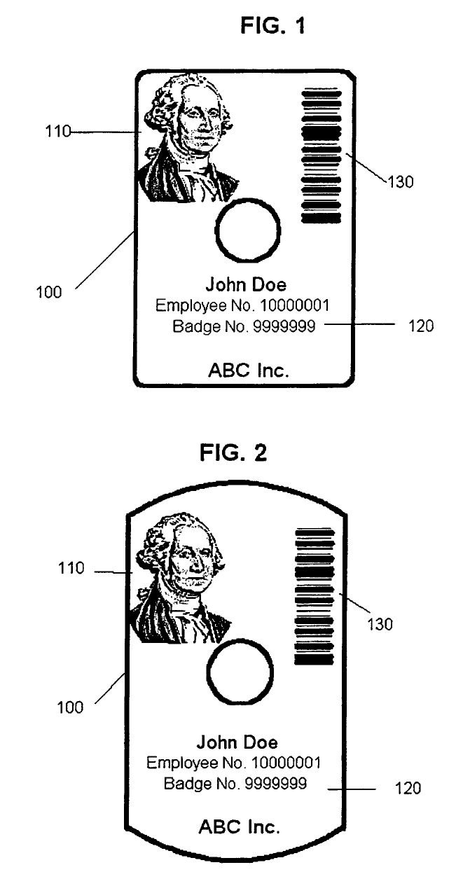

FIG. 1 illustrates an example of a physical representation of a removable computer storage medium 100 that is somewhat rectangular shaped, The removable computer storage medium is based on the standard compact disc (CD) but has been physically altered in shape to be more portable. This shape CD is readily available from commercial sources of CD media and may be inserted into standard CD trays for reading purposes. Standard CDs are present on an overwhelming majority of computers in use today. The removable computer storage medium has been imprinted or labeled with the picture 110 of the individual it has been issued to as well as textual identification 120 of the individual. The text 120 includes, but is not limited to, name, organization, employee number, and badge number. Moreover, a bar code 130 may be included that can be scanned by various security devices responsible for granting or denying access to the resources they are charged to secure. A magnetic strip may be substituted for the bar code provided sufficient precautions are taken to ensure that the actual data on the removable computer storage medium is not corrupted when the removable computer storage medium is subjected to a magnetic reader. One of ordinary skill in the art can readily adapt other forms of electronic identification without departing from the spirit or scope of the present invention.

FIG. 2 illustrates an example of a physical representation of a removable computer storage medium that is rectangular in shape with the short ends being rounded off. This is another readily available CD media shape. This design includes all of the same information and characteristics as the removable computer storage medium shown in FIG. 1.

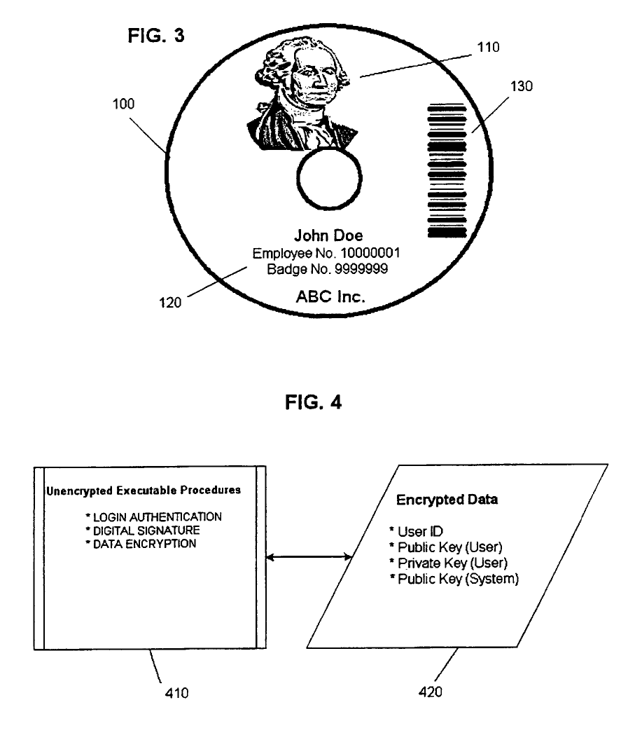

FIG. 3 illustrates an example of a physical representation of a removable computer storage medium that is circular in shape and readily available. This design is more traditional with respect to compact discs (only smaller) and may also may be inserted into standard CD trays for reading purposes. It includes all of the same information and characteristics as the removable computer storage medium shown in FIG. 1.

FIG. 4 is a block diagram illustrating the programs and data stored on a removable computer storage medium. The removable computer storage medium may contain executable programs 410 that are usually unencrypted and encrypted data 420 used in conjunction with the executable programs. The programs include, but are not limited to, login authentication procedures, digital signature procedures, and data encryption procedures. The removable computer storage medium may also contain files for the installation on the computer system of data encryption and digital signature applications. The encrypted data includes, but is not limited to, a user ID, encryption key data pertaining to a computer system, and encryption key data pertaining to the individual user. The encryption key or keys may be public and private keys in a PKI system or symmetric keys for symmetric key encryption.

A single removable computer storage medium can be compatible with multiple computer systems. A computer system is essentially a network of computers. For instance, in a corporate environment, there could be separate computer systems for procurement, human resources, time card management, etc. It is possible that one individual would need access to more than one of the computer systems in the course of performing their duties. In such cases, the individual's removable computer storage medium would include programs and data particular to each computer system.

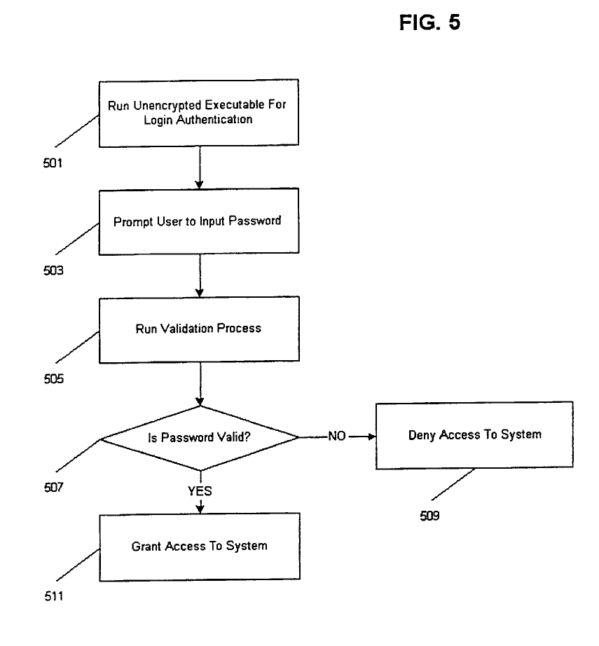

FIG. 5 is a flowchart describing a log-in procedure for a given computer system. In order to gain access to a given computer or computer system, an individual loads his or her removable computer storage medium into the appropriate receptacle of the selected computer. It is assumed that the computer has already been booted up and is in a ready state. If this is not the case the computer must be booted up. The removable computer storage medium does not interfere with the boot up process, thus the removable computer storage medium may be loaded prior to booting up the computer.

The computer, either automatically or via manual manipulation, runs a login authentication program 501 resident on the removable computer storage medium or previously installed on the computer system. The user is prompted 503 for the ID password combination or alternatively just the password. The program uses a combination of user ID and password or just password to validate the user 505 in one of many valid algorithmic methods for doing so. Once a validation decision 507 has been made, deeming the password invalid denies access 509 to the computer system. However, if the password is deemed valid then access is granted 511 to the computer system.

This method requires that the removable computer storage medium must be readable by the computer in order to gain access to the computer system because the user ID may only be read from the removable computer storage medium itself. It cannot be input in the manner that the password is input. Thus, someone wishing to access a computer system must have physical possession of a removable computer storage medium as well as knowledge of its associated password. This adds an additional layer of security since possession and knowledge are required as opposed to just knowledge.

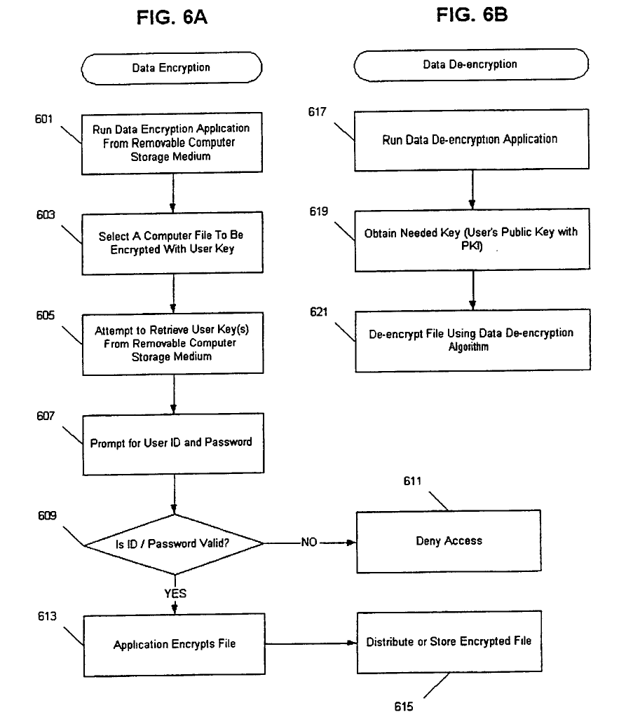

FIG. 6A is a flowchart describing the encryption of a data file. The user runs a data encryption program 601 that may be resident on the removable computer storage medium, resident on the computer system or installed onto the computer system from the removable computer storage medium. While the program is running, the user retrieves 603 the desired computer file to be encrypted. The application then attempts to retrieve 605 the needed keys from the removable computer storage medium. The user is prompted 607 for ID and Password. The users ID and Password are put through a validation process 609. If the password is invalid then access is denied 611 and data encryption cannot occur. Otherwise, the application implements the data encryption algorithm 613 with the user's key(s). The data encryption algorithm implemented may be any of several currently known algorithms or future developed algorithms including, but not limited to, a symmetric key algorithm or a public/private key algorithm. Retrieval of additional keys from an address book or from a public repository may be necessary to complete the algorithm. The encrypted file is then sent or stored 615 for later de-encryption.

FIG. 6B is a flowchart describing a data de-encryption procedure. To deencrypt an encrypted file the recipient first runs 617 the application that supports data deencryption. The recipient then obtains 619 a copy of the needed key from a trusted third party agent that maintains the key distribution infrastructure. The key is then used to deencrypt 621 the user encrypted file.

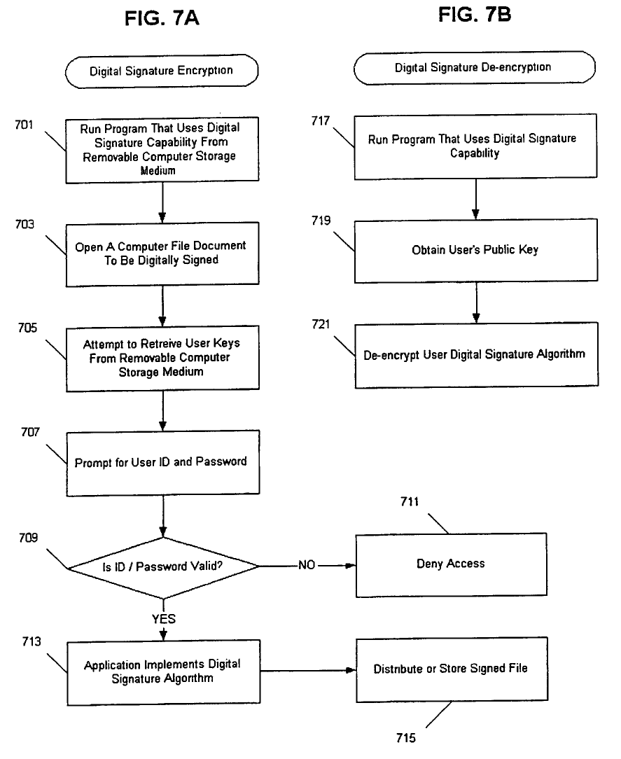

FIG. 7A is a flowchart describing a digital signature encryption procedure. The user loads his or her removable computer storage medium into the appropriate receptacle of a given computer and performs a login authentication procedure if not already done. The user then runs a digital signature encryption program 701 that may be resident on removable computer storage medium, resident on the computer system or installed onto the computer system from the removable computer storage medium. While the program is running, the user retrieves and opens 703 the desired computer file to be digitally signed. The application then attempts to retrieve 705 the needed keys from the removable computer storage medium. The user is prompted 707 for a user ID and password. The user ID and password are checked by a validation procedure 709. If the user ID and password combination is invalid then access is denied 711 and the digital signature procedure is aborted. Otherwise, the application implements the digital signature algorithm 713 with the user's key information obtained from the removable computer storage medium.

The digital signature algorithm implemented may be any of several currently known such as a symmetric key algorithm or a public/private key algorithm. Moreover, future developed algorithms may be included on a removable computer storage medium, if desired, when they are developed. Retrieval of additional keys from an address book or from a public repository may be necessary depending on the algorithm being implemented. The digitally signed file is then sent or stored 715 for later de-encryption.

FIG. 7B is a flowchart describing a digital signature de-encryption procedure. To de-encrypt a file with a digital signature, the recipient first runs 717 an application that supports digital signatures. The recipient then obtains the needed key 719 from a trusted third party agent that maintains the key distribution infrastructure. The appropriate keys are then used to de-encrypt 721 the digital signature algorithm.

It is important to note that the actual login authentication, digital signature, and data encryption techniques or algorithms can vary from removable computer storage medium to removable computer storage medium. Thus, any commercial or private procedures may be employed with the removable computer storage medium concept of the present invention without departing from the spirit or scope of the present invention. It does not matter which vendor is chosen to supply the encryption technology. The concept promoted by the present invention is to integrate physical security and computer security by including any combination of digital signature, encryption, or login authentication programs and data on a standard removable computer storage medium that also exhibits physical security aspects. The physical security aspects of the removable computer storage medium include, but are not limited to, an imprint of the user's picture and other identification information. To further enhance the value of the removable computer storage medium identification apparatus, other means of electronic identification such as a bar code can also be imprinted on the removable computer storage medium. With the addition of a bar code containing information pertaining to the owner/user, the removable computer storage medium can be scanned at various points for various identification verification purposes.

It is preferred that the removable computer storage medium be imprinted with the physical identification data. A printed label may be used but is subject to removal and tampering whereas imprinted data is harder to alter and thus subject to less fraud.

There are several advantages realized by the present invention. The present invention can be used to enable many different data encryption and security features. For instance, it can be used as a part of a computer login authentication system that grants or denies access to certain computer or network resources. In addition, it can be used for electronic or digital signatures as a part of a system to electronically “sign” documents. Another use is data encryption to encrypt and/or de-encrypt data. All of these features are conveniently stored on a single removable computer storage medium that can double as a physical identification badge. By consolidating the physical and computer security needs of an organization to a single apparatus for each member of the organization, significant security enhancements and economies can be realized.

Perhaps the most attractive feature of the present invention lies in the choice of the removable computer storage medium. By choosing a media such as the pocket CD the present invention can be implemented without the requirement or additional expense of adding special hardware to a computer or computer system. Thus, the present invention can be rapidly deployed into today's marketplace. Moreover, a pocket CD is approximately the size of many identification badges being used today.

It is to be understood that the present invention illustrated herein is readily implementable by those of ordinary skill in the art as a computer program product having a medium with computer program(s) embodied thereon. The computer program product is capable of being loaded and executed on the appropriate computer processing device(s) in order to carry out the method or process steps described. Appropriate computer program code in combination with hardware implements many of the elements of the present invention. This computer code is typically stored on removable storage media. This removable storage media includes, but is not limited to, a diskette, standard CD, pocket CD, DVD, zip disk, or mini zip disk. Additionally, the computer program code can be transferred to the appropriate hardware over some type of data network.

The present invention has been described, in part, with reference to flowcharts or logic flow diagrams. It will be understood that each block of the flowchart diagrams or logic flow diagrams, and combinations of blocks in the flowchart diagrams or logic flow diagrams, can be implemented by computer program instructions.

These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks or logic flow diagrams.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart blocks or logic flow diagrams. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart blocks or logic flow diagrams.

Accordingly, block(s) of flowchart diagrams and/or logic flow diagrams support combinations of means for performing the specified functions, combinations of steps for performing the specified functions and program instruction means for performing the specified functions. It will also be understood that each block of flowchart diagrams and/or logic flow diagrams, and combinations of blocks in flowchart diagrams and/or logic flow diagrams can be implemented by special purpose hardware-based computer systems that perform the specified functions or steps, or combinations of special purpose hardware and computer instructions.

In the following claims, any means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

1. A removable computer storage medium comprising:
physical aspects visible on a surface of said removable computer storage medium including:
an identification photograph of an individual to be associated with the removable computer storage medium; and
textual identification data for the individual to be associated with the removable computer storage medium;
executable software procedures encoded onto said removable computer storage medium including:
a login authentication procedure for accessing a secure computer system;
a digital signature procedure for digitally signing electronic documents; and
a data encryption procedure for encrypting electronic data, and
data encoded onto said removable computer storage medium including:
user ID and password data for use in verifying the authorization status of the individual to be associated with the removable computer storage medium;
user encryption key data corresponding to the individual to be associated with the removable computer storage medium; and
system encryption key data corresponding to a computer system.

2. The removable computer storage medium of claim 1, wherein said physical aspects visible on a surface of the removable computer storage medium further include a bar code containing data pertaining to the individual to be associated with the removable computer storage medium.

3. The removable computer storage medium of claim 1, wherein said physical aspects visible on a surface of the removable computer storage medium are imprinted onto said surface of said removable computer storage medium.

4. The removable computer storage medium of claim 1, wherein said physical aspects visible on a surface of the removable computer storage medium are included on a printed label attachable to said surface of said removable computer storage medium.

5. The removable computer storage medium of claim 1, wherein the removable computer storage medium is a pocket CD.

6. The removable computer storage medium of claim 1, wherein the removable computer storage medium is a standard CD.

7. The removable computer storage medium of claim 1, wherein the removable computer storage medium is a floppy diskette.

8. The removable computer storage medium of claim 1, wherein the removable computer storage medium is a zip disk.

9. The removable computer storage medium of claim 1, wherein the removable computer storage medium is a mini zip disk.

10. The removable computer storage medium of claim 1, wherein the removable computer storage medium is a DVD.

11. A removable computer storage medium comprising:
physical aspects visible on a surface of said removable computer storage medium including:
an identification photograph of an individual to be associated with the removable computer storage medium; and
textual identification data for the individual to be associated with the removable computer storage medium;
executable software procedures encoded onto said removable computer storage medium including:
a login authentication procedure for accessing a secure computer system; and
a data encryption procedure for encrypting electronic data; and
data encoded onto said removable computer storage medium including:
user ID and password data for use in verifying the authorization status of the individual to be associated with the removable computer storage medium; and
user encryption key data corresponding to the individual to be associated with the removable computer storage medium.

12. The removable computer storage medium of claim 11, wherein said physical aspects visible on a surface of the removable computer storage medium further include a bar code containing data pertaining to the individual to be associated with the removable computer storage medium.

13. The removable computer storage medium of claim 11, wherein said physical aspects visible on a surface of the removable computer storage medium are imprinted onto said surface of said removable computer storage medium.

14. The removable computer storage medium of claim 11, wherein said physical aspects visible on a surface of the removable computer storage medium are included on a printed label attachable to said surface of said removable computer storage medium.

15. The removable computer storage medium of claim 11, wherein the removable computer storage medium is a pocket CD.

16. The removable computer storage medium of claim 11, wherein the removable computer storage medium is a standard CD.

17. The removable computer storage medium of claim 11, wherein the removable computer storage medium is a floppy diskette.

18. The removable computer storage medium of claim 11, wherein the removable computer storage medium is a zip disk.

19. The removable computer storage medium of claim 11, wherein the removable computer storage medium is a DVD.

20. The removable computer storage medium of claim 11, wherein the removable computer storage medium is a mini zip disk.

21. A removable computer storage medium comprising:
physical aspects visible on a surface of said removable computer storage medium including an identification photograph and textual identification data pertaining to an individual to be associated with the removable computer storage medium;
executable software procedures encoded onto said removable computer storage medium including a login authentication procedure for accessing a secure computer system; and
data encoded onto said removable computer storage medium including user ID and password data for use in verifying the authorization status of the individual to be associated with the removable computer storage medium.

22. The removable computer storage medium of claim 21, wherein said physical aspects visible on a surface of the removable computer storage medium further include a bar code containing data pertaining to the individual to be associated with the removable computer storage medium.

23. The removable computer storage medium of claim 21, wherein said physical aspects visible on a surface of the removable computer storage medium are imprinted onto said surface of said removable computer storage medium.

24. The removable computer storage medium of claim 21, wherein said physical aspects visible on a surface of the removable computer storage medium are included on a printed label attachable to said surface of said removable computer storage medium.

25. The removable computer storage medium of claim 21, wherein the removable computer storage medium is a pocket CD.

26. The removable computer storage medium of claim 21, wherein the removable computer storage medium is a standard CD.

27. The removable computer storage medium of claim 21, wherein the removable computer storage medium is a floppy diskette.

28. The removable computer storage medium of claim 21, wherein the removable computer storage medium is a zip disk.

29. The removable computer storage medium of claim 21, wherein the removable computer storage medium is a DVD.

30. The removable computer storage medium of claim 21, wherein the removable computer storage medium is a mini zip disk.

31. A method of creating a removable computer storage medium comprising:
imprinting a surface of said removable computer storage medium with physical identification characteristics pertaining to an individual to be associated with the removable computer storage medium;
encoding said removable computer storage medium with security procedures; and
encoding said removable computer storage medium with security data.

32. The method of claim 31, wherein said physical identification characteristics include an identification photograph of the individual to be associated with the removable computer storage medium.

33. The method of claim 31, wherein said physical identification characteristics include textual identification data pertaining to the individual to be associated with the removable computer storage medium.

34. The method of claim 31, wherein said physical identification characteristics include a bar code containing data pertaining to the individual to be associated with the removable computer storage medium.

35. The method of claim 31, wherein said security procedures include a login authentication procedure for accessing a secure computer system.

36. The method of claim 31, wherein said security procedures include a data encryption procedure for encrypting electronic data.

37. The method of claim 31, wherein said security procedures include a digital signature procedure for digitally signing electronic documents.

38. The method of claim 31, wherein said security data include user ID and password data for use in verifying the authorization status of the individual to be associated with the removable computer storage medium.

39. The method of claim 31, wherein said security data include user encryption key data corresponding to the individual to be associated with the removable computer storage medium.

40. The method of claim 31, wherein said security data include system encryption key data corresponding to a computer system.
